(19) United States
(12) Patent Application Publication
(10) Pub. No.: US 2006/0114083 A1
(43) Pub. Date: Jun. 1, 2006

(54) Air cavity module for planar type filter operating in millimeter-wave frequency bands

(76) Inventors: Hong Yeol Lee, Heungdeok-gu (KR); Dong Suk Jun, Yuseong-gu (KR); Dong Young Kim, Yuseong-gu (KR); Sang Seok Lee, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/150,974

(22) Filed: Jun. 13, 2005

(30) Foreign Application Priority Data
Dec. 1, 2004 (KR) 2004-99920

(51) Int. Cl. H01P 1/203

(52) U.S. Cl. 333/204

(57) ABSTRACT

Provided is an air cavity module for a planar type filter operating in millimeter-wave frequency bands. The air cavity module includes: the planar type filter operating in the millimeter frequency bands; an air cavity having open side and top surfaces to mount the planar type filter therein; and an air cavity cover closing up the open top surface of the air cavity to allow the transmission of signals from and into the planar type filter. The air cavity module can lessen both transmission loss and radiation loss to improve the characteristics of the filter that operates in the millimeter-wave frequency bands.

### CROSS-REFERENCE TO RELATED APPLICATION

This application claims priority to and the benefit of Korean Patent Application No. 2004-99920, filed Dec. 1, 2004, the disclosure of which is incorporated herein by reference in its entirety.

### BACKGROUND

1. Field of the Invention

The present invention relates to an air cavity module for a planar type filter operating in millimeter-wave frequency bands and, more specifically, to an air cavity module for a planar type filter operating in millimeter-wave frequency bands, in which cavity resonance is eliminated from an air cavity for a planar type filter and the planar type filter is completely mounted in the air cavity, so that both transmission loss and radiation loss can be reduced to improve the characteristics of the filter that operates in the millimeter-wave frequency bands.

2. Discussion of Related Art

In general, as the development of wireless communication technology has been accelerated and the amount of processed data has increased, the operating frequency of wireless communication systems has been spontaneously reaching millimeter-wave frequency bands of several tens of GHz or higher. In this connection, components for the wireless communication systems have been scaled down, and above all, a radio frequency (RF) filter, which is a passive component, has been small-sized such that it can be made using a semiconductor process.

Also, as the operating frequency of the wireless communication systems becomes higher and the RF filter becomes smaller, the RF filter is more susceptible to the environment and may be seriously damaged due to radiation loss.

It is difficult to find an exemplary conventional technique of an air cavity for a planar type filter that operates in the frequency band of several tens of GHz or higher because the technique is not yet generalized. However, there is a disclosure having similar objects, which is directed to a ceramic package for a surface acoustic wave (SAW) filter that operates in low frequency bands. In the disclosure, a filter is mounted in the ceramic package, and an electrode of the filter and an electrode of a ceramic module are connected using a wire bonding process, thereby enabling the transmission of signals.

The above-described ceramic package is aimed at protecting components against external shock and, particularly, protecting the SAW filter, which is susceptible to the environment, by cutting off externally generated electromagnetic waves.

However, once the operating frequency of the SAW filter exceeds several tens of GHz, all spaces between the components and the cavity bring about unpredictable cavity spaces. Thus, the SAW filter may be seriously damaged, the bonded wire itself may operate as a parasitic factor, and transmission loss may increase.

As another similar example, there is a receiver for a wireless communication system that operates in the frequency band of 20 GHz. The receiver for the wireless communication system is formed as a system on packaging (SOP) type on a multilayered benzocyclobutene (BCB) layer formed on a silicon substrate.

In this case, components as active devices are bonded as a flip-chip type onto the BCB layer. A dual mode resonator (DMR) pattern is printed as an inverted microstrip line (IMSL) on the BCB layer, and a planar type filter as a passive device is covered by and bonded to a cavity, which is obtained by etching the surface of the silicon substrate to a shallow depth using a dry etching process and covering the etched surface with a metal.

Because all the components are mounted on the line printed on the same substrate, interconnection loss between the components may be reduced. Also, the cavity formed in the silicon substrate covers the planar type filter so that transmission loss may be lessened.

However, since the planar type filter is not completely mounted in the cavity, signals are leaked through the silicon substrate on which the BCB layer is formed, thus resulting in great transmission loss and poor attenuation characteristics.

### SUMMARY OF THE INVENTION

The present invention is directed to an air cavity module for a planar type filter operating in millimeter-wave frequency bands, in which cavity resonance is eliminated from an air cavity for a planar type filter and the planar type filter is completely mounted in the air cavity, so that both transmission loss and radiation loss can be reduced to improve the characteristics of the filter that operates in millimeter-wave frequency bands.

One aspect of the present invention is to provide an air cavity module for a planar type filter operating in millimeter-wave frequency bands, which includes: the planar type filter operating in the millimeter frequency bands; an air cavity having open side and top surfaces to mount the planar type filter therein; and an air cavity cover closing up the open top surface of the air cavity to allow the transmission of signals from and into the planar type filter.

The planar type filter may be one of a coplanar waveguide (CPW) type planar filter and a microstrip line (MSL) type planar filter.

The air cavity may have a square box shape with both side surfaces and a top surface open.

A first hole and a second hole may be formed in both edge portions of the air cavity cover, respectively. Here, the first hole allows the inputting of an electric signal into the planar type filter and the second hole allows the detecting of an electric signal output from the planar type filter.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a construction diagram of an air cavity module for a planar type filter operating in millimeter-wave frequency bands according to an exemplary embodiment of the present invention;

FIG. 2 is a front view of the air cavity module shown in FIG. 1;

FIG. 3 is a plan view of the air cavity module shown in FIG. 1;

FIG. 4 is a graph of simulation results showing the frequency response characteristics of a planar type filter without the air cavity module of FIG. 1; and

FIG. 5 is a graph of simulation results showing the frequency response characteristics of a planar type filter with the air cavity module of FIG. 1.

### DETAILED DESCRIPTION OF EXEMPLARY EMBODIMENTS

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to those skilled in the art.

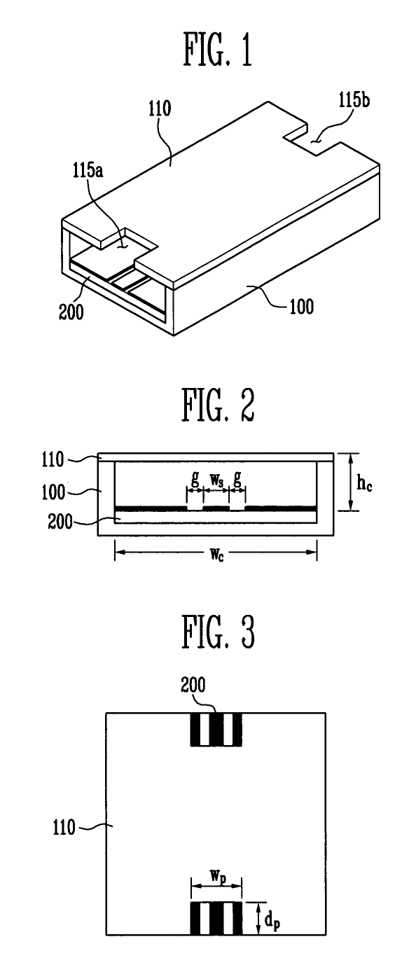

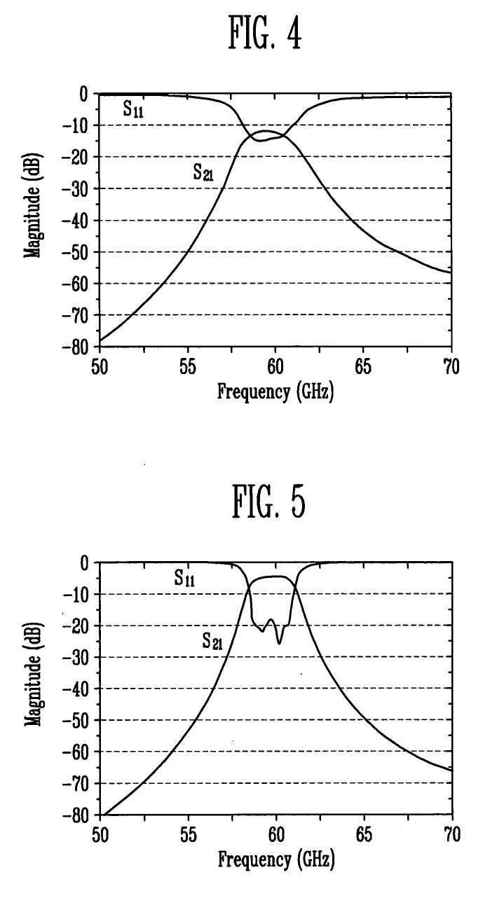

FIG. 1 is a construction diagram of an air cavity module for a planar type filter operating in millimeter-wave frequency bands according to an exemplary embodiment of the present invention, and FIGS. 2 and 3 are a front view and a plan view of the air cavity module shown in FIG. 1, respectively.

Referring to FIGS. 1 through 3, the air cavity module for the planar type filter operating in millimeter-wave frequency bands includes an air cavity 100, an air cavity cover 110, and a planar type filter 200 that operates in millimeter-wave frequency bands.

Specifically, in the air cavity module for the planar type filter operating in the millimeter-wave frequency bands according to the present invention, the planar type filter 200 is mounted in the air cavity 100, and the air cavity 100 is covered by and bonded to the air cavity cover 110.

In this case, the air cavity 100 may have a square box shape with both side surfaces and a top surface open such that the planar type filter 200 is easily mounted therein.

The air cavity cover 110 may close up the top surface of the air cavity 100 so as to enable the transmission of signals from and into the planar type filter 200.

In other words, a first hole 115a and a second hole 115b are formed in both edge portions of the air cavity cover 110, respectively. The first hole 115a is used to input an electric signal into the planar type filter 200, whereas the second hole 115b is used to detect an electric signal output from the planar type filter 200.

The planar type filter 200 may be one of a coplanar waveguide (CPW) type filter and a microstrip line (MSL) type filter. Also, if the planar type filter 200 is the CPW type filter, it may be one of a grounded CPW type filter and an ungrounded CPW type filter.

Referring to FIG. 2, when w_{c} refers to the width of the air cavity 100 and h_{c} refers to the height of the air cavity 100, which corresponds to a distance between the planar type filter 200 and the air cavity cover 10, they can be obtained within the following ranges to eliminate cavity resonance and lessen radiation loss:

w_{c}≧3(2 g+wₛ); in the case of a CPW type filter

w_{c}≧5 wₛ; in the case of an MSL type filter

0.25λg≦h_{c}≦0.5 kg,

where wₛ is the width of a signal line of the planar type filter 200, and g is a distance between the signal line and a ground plane in the planar type filter 200.

The first and second holes 115a and 115b of the air cavity cover 110 make the air cavity 100 open in the vertical direction and enable measurements and a wire bonding process, and each of them has a width wₚ and a depth dₚ. Here, wₚ should be sufficient to put a probe for measurements or a wire for wire bonding into the air cavity 200, and dₚ should be not more than ¼ the guided wavelength.

FIG. 4 is a graph of simulation results showing the frequency response characteristics of the planar type filter 200 without the air cavity module of FIG. 1.

Referring to FIG. 4, the planar type filter 200 was designed as a CPW type 4-pole bandpass filter having a center frequency of about 60 GHz. From the standpoint of frequency response characteristics, a curve S₁₁ does not exceed 15 dB at 60 GHz, and a curve S₂₁ exhibits a greater transmission loss than 10 dB at 60 GHz. Since the curves S_{11 and S}₂₁ are generally gentle, it can be interpreted that the frequency response characteristics of the filter 200 are affected by radiation loss.

FIG. 5 is a graph of simulation results showing the frequency response characteristics of the planar type filter 200 with the air cavity module of FIG. 1.

Referring to FIG. 5, the simulation was conducted using the planar type filter 200, which includes the air cavity 100 having a width w_{c} of 0.7 mm and a height h_{c} of 0.5 mm and the hole having a width wₚ of 0.4 mm and a depth dₚ of 0.5 mm. A curve S₁₁ approximates to 20 dB at about 60±2 GHz, and a curve S₂₁ reaches 4 dB or less at about 60±2 GHz. That is, the filter 200 has excellent frequency response characteristics.

From the simulation results shown in FIGS. 4 and 5, it can be confirmed that the air cavity module according to the exemplary embodiment of the present invention can notably reduce the transmission loss and radiation loss.

As described above, in the air cavity module for a planar type filter operating in millimeter-wave frequency bands according to the present invention, cavity resonance is eliminated from an air cavity for a planar type filter and the planar type filter is completely mounted in the air cavity. Hence, both transmission loss and radiation loss can be lessened to improve the characteristics of the filter that operates in the millimeter-wave frequency bands.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

What is claimed is:

1. An air cavity module for a planar type filter operating in millimeter-wave frequency bands, comprising:
the planar type filter operating in the millimeter frequency bands;
an air cavity having open side and top surfaces to mount the planar type filter therein; and
an air cavity cover closing up the open top surface of the air cavity to allow the transmission of signals from and into the planar type filter.

2. The air cavity module according to claim 1, wherein the planar type filter is one of a coplanar waveguide (CPW) type planar filter and a microstrip line (MSL) type planar filter.

3. The air cavity module according to claim 1, wherein the air cavity has a square box shape with both side surfaces and a top surface open.

4. The air cavity module according to claim 1, wherein a first hole for inputting an electric signal into the planar type filter and a second hole for detecting an electric signal output from the planar type filter are formed in both edge portions of the air cavity cover, respectively.
